(19) United States
(12) Patent Application Publication
(10) Pub. No.: US 2008/0020009 A1
(43) Pub. Date: Jan. 24, 2008

(54) Fungicidal composition comprising nanometer sized oil particle and method of manufacturing the same

(76) Inventor: Kyu-Heon Lee, Port Moody (CA)

Correspondence Address: SUGHRUE MION, PLLC, 2100 PENNSYLVANIA AVENUE, N.W., SUITE 800, WASHINGTON, DC, 20037, US

(21) Appl. No.: 11/588,394

(22) Filed: Oct. 27, 2006

(30) Foreign Application Priority Data
Nov. 18, 2005 (KR) 10-2005-0110543

(51) Int. Cl. A01N 25/00

(52) U.S. Cl. 424/405; 977/902

(57) ABSTRACT

Disclosed are a fungicidal composition comprising oil, an emulsifier and water, and a method for preparing the same. The fungicidal composition is an oil-in-water (o/w) type emulsion that can be obtained by spraying the oil and emulsifier to ionized water. The oil is presented as particles with a particle diameter of 20˜50 nm in the fungicidal composition. The fungicidal composition not only shows an excellent fungicidal effect, but also prevents the problems of oil/water separation upon dilution and an increase in viscosity at low temperature, and does not adversely affect plants.

This application claims the benefit of the filing date of Korean Patent Application No. 10-2005-0110543, filed on Nov. 18, 2005 in the Korean Intellectual Property Office, the disclosure of which is incorporated herein in its entirely by reference.

### TECHNICAL FIELD

The present invention relates to an environmental and echo-friendly fungicidal composition having an excellent fungicidal effect, and a method for preparing the same.

### BACKGROUND ART

In the field of agriculture, agricultural chemicals are required to prevent or exterminate insects or fungi, which are harmful to plants. However, as agricultural chemicals are toxic, they cause not only environmental pollution but also contamination of animals and plants. Hence, many attempts have been recently made in order to reduce environmental pollution or contamination of animals and plants by reducing the consumption of agricultural chemicals, by promoting the use of environmentally friendly agricultural chemicals such as microorganism agents, or by using natural enemies of harmful insects.

Currently, various types of agents are used in order to prevent or exterminate fungi in the field of agriculture, and particular examples of such agents include chemical agents, microorganism agents and plant extract-based agents. However, if a chemical agent is used over a long period, there is a problem related to the developed resistance of fungi to the chemical agent. In this case, there is another problem in that the chemical agent remaining on agricultural crops causes damage to the environment and to the human body. Additionally, micro-organism agents show different degrees of effects depending on their culture conditions, contamination degrees and survival ratios, and thus they are limited in the use as agents for controlling harmful insects or fungi. Furthermore, plant extract-based agents are not cost-efficient and they have difficulty in ensuring the uniformity of active components, depending on the organ, place and time for carrying out extraction, and. Also, plant extract-based agents cannot ensure a constant and uniform effect, because they are oxidized or reduced upon exposure to the external environment.

Recently, considering these circumstances, there have been attempts to use an oil agent as an environmentally friendly sterilizing agent or fungicidal agent. It is known that when oil is dispersed in water and then the dispersion is sprayed onto plants, it is possible to cause problematic conditions in the biological activities and metabolism of fungi or microbes through the oil so that the fungi or microbes can be destroyed, while not adversely affecting the plants. Hence, intensive research and development for such oil type environmentally friendly fungicidal agents has been carried out.

It is known that the oil component used in such oil type agents is effective for the prevention or extermination fungi, and does not allow the fungi to be resistant against the oil. Particularly, because vegetable oils are not harmful to the environment or the human body, prevention or extermination of harmful insects or fungi using such vegetable oils becomes the focus of intention. For example, in North America, various kinds of vegetable oils, including soybean oil, canola oil, cottonseed oil, corn oil and various kinds of essences, have been used as agents for preventing harmful insects or fungi since 1959. Particularly, soybean oil has been designated as an agricultural biochemical agent by the EPA. In the USA, soybean oil has been used as an agent for preventing harmful insects or fungi, to a level of at least 60,000 tons per year, in the winter season and the summer season. Also, the effect of soybean oil is disclosed in part (United Soybean Board, 1998).

However, most conventional fungicidal agents based on an oil component have a high viscosity at low temperature, and thus are difficult to spray onto plants. Additionally, if an oil dilution is left as it is, oil/water separation occurs so that the oil shows poor efficacy (Feedstocks, Vol 3, Issue 5 November 1998). Moreover, conventional oil-based fungicidal agents have a large oil particle size, and thus inhibit photosynthesis of plants when attached to plants, thereby adversely affecting the plants. Therefore, such conventional agents are limited in the use as agricultural chemicals and show poor efficacy.

### DISCLOSURE OF THE INVENTION

Therefore, the present invention has been made mainly on account of the above-mentioned problems. The present inventors studied to provide an environmentally friendly agricultural chemical which has an excellent fungicidal effect.

The present inventors have found that when oils such as soybean oil, an emulsifier and ionized water are used to form a dispersion comprising nanometer-sized oil particles dispersed in water, the oil particles and water can be stored stably in a state of emulsion over a long period. The present inventors have also found that when the above emulsion is diluted and sprayed onto plants, it is possible to obtain an improved fungicidal effect, and to solve the problems related to conventional oil-based agents according to the prior art. Such problems include an oil/water separation phenomenon that occurs in the dilution, and increased viscosity of such agents at low temperature. Moreover, such agents are problematic in that they may adversely affect the plants. Additionally, according to the present invention, it has been found that when oil and an emulsifier are mixed, and the mixture is heated and then sprayed into ionic water that is ionized under a high voltage, the oil particles are dispersed efficiently in water to a nanometer size, more particularly to a size of 20˜50 nm.

Therefore, it is an object of the present invention to provide a fungicidal composition, which has an excellent fungicidal effect while not adversely affecting plants, and a method for preparing the same.

According to an aspect of the present invention, there were provided a fungicidal composition comprising oil, an emulsifier and ionic water, which is presented as an oil-in-water (o/w) type emulsion. Also, it comprises 5˜30 parts by weight of the emulsifier and 50˜100 parts by weight of water based on 100 parts by weight of the oil, wherein the water is ionized, and the oil is dispersed in the ionized water in a state of particles having a particle diameter of 20˜50 nm.

Also, based on another aspect of the present invention, there were provided a method for preparing a fungicidal composition comprising nanometer sized oil particles, which comprises the steps of:

(a) mixing oil with an emulsifier;

(b) preheating the mixture obtained from step (a) to 50˜60° C.;

(c) applying a high voltage to water to perform ionization of water; and

(d) injecting the mixture obtained from step (b) into the ionized water obtained from step (c) by using a high-pressure spraying device with stirring to allow the oil to be dispersed in the ionized water in a state of nanometer sized particles.

The fungicidal composition according to the present invention may be used after diluting it with water. In case of such diluted compositions, the oil particles are maintained in the state of being nanometer sized particles, and thus they are attached easily to cell walls of fungi such as molds. Thus, it is possible to obtain an excellent fungicidal effect and to prevent the problems of an oil/water separation phenomenon and an increase in viscosity at low temperature.

Hereinafter, the present invention will be explained more in detail.

In general, conventional fungicidal agents merely comprising oil and an emulsifier are prepared by mixing oil with the emulsifier, and are used for the prevention or extermination of harmful insects or fungi after simple dilution thereof with water. In this case, oil particles present in the emulsion obtained as described above have a particle diameter of several micrometers to several hundreds of micrometers. However, as described hereinbefore, such large oil particles, as having a diameter of several micrometers to several hundreds of micrometers, cause the problems of damage to plants, oil/water separation occurring in a dilution, and an increase in viscosity at low temperature.

To solve these problems, the fungicidal composition comprising oil, an emulsifier and ionized water according to the present invention is characterized in that the oil particles have a nanometer size. In other words, such nanometer-sized oil particles can protect plants from being damaged due to the inhibition of respiration and photosynthesis of plants caused by large oil particles that block the cell membranes and cell walls. Also, such nanometer-sized oil particles can prevent the problems of oil/water separation occurring in a dilution, and an increase in viscosity at low temperature.

Additionally, nanometer-sized oil particles can protect cell walls of hyphae or spores of fungi, or can penetrate into the cells through the outer or inner cell walls, depending on oil particle sizes, thereby causing an ionic disturbance or osmotic pressure effect, resulting in destruction of the cells. Therefore, it is possible to obtain an improved fungicidal effect compared to conventional fungicidal agents.

The fungicidal composition according to the present invention may be obtained by the method comprising the steps of:

(a) mixing oil with an emulsifier;

(b) preheating the mixture obtained from step (a) to 50˜60° C.;

(c) applying a high voltage to water to perform ionization of water; and

(d) injecting the mixture obtained from step (b) into the ionized water obtained from step (c) by using a high-pressure spraying device with stirring to allow the oil to be dispersed in the ionized water in a state of nanometer sized particles.

According to the above method, it is possible to make oil particles with a particle diameter of 20˜50 nm. Such oil particles with a particle diameter of 20˜50 nm show an excellent fungicidal efficacy, and thus provides an excellent fungicidal effect even when used in a small amount. Moreover, respiration or photosynthesis of plants is not inhibited by such oil particles. If the oil particles have a particle diameter of greater than 50 nm, agglomeration and enlargement of oil particles occur undesirably, resulting in water/oil separation. It is preferable that the oil particles have a size as small as possible. However, oil particles with a particle diameter of less than 20 nm need a very high pressure for spraying, and thus are not cost-efficient.

Meanwhile, in step (c) of ionizing water, water may be ionized by treating water at a high voltage in the presence of a metal catalyst.

Although there is no particular limitation in the high voltage used in step (c), a voltage ranging from 10,000V to 60,000V is preferred in terms of cost efficiency. Even if the voltage is higher than 60,000V, any improvement cannot be obtained in the ionization of water. Therefore, a voltage of higher than 60,000V is not cost efficient. On the other hand, if the voltage is lower than 10,000V, ionization cannot be performed sufficiently. Thus, such low voltage should be applied over a longer period, and thus is not cost-effective. Meanwhile, the high voltage applied in step (c) may also be applied in step (d). Further, such high voltage, as applied when spraying the mixture of oil and emulsifier to the ionized water, is favorable to the dispersion of oil particles.

According to the present invention, high voltage application generates a magnetic field, to which water molecules and an iron catalyst are subjected. Hence, water molecules are ionized and oil can be dispersed uniformly in water, thereby allowing the oil to be dispersed in oil in the state of nanometer-sized particles. Also, agglomeration of such dispersed oil particles is prevented.

Oil particles agglomerate among themselves with the lapse of time, when they are dispersed in water. To prevent such agglomeration, an emulsifier is used. However, the emulsifier cannot prevent the agglomeration of oil particles by itself. The emulsifier reduces the surface energy, and thus allows the oil in a composition to be present as particles upon the preparation of the composition. However, oil particles dispersed in water agglomerate among themselves with the lapse of time so that water/oil phase separation occurs. Accordingly, conventional oil-based fungicidal agents are generally provided in the form of oil mixed with an emulsifier. When such agents are used, they are first diluted with water for spraying.

However, according to the present invention, the oil particles have a small size by virtue of the use of ionized water formed under a high voltage. Thus, the oil particles can be present in the form of nanometer-sized particles in water over a long period of time due to the intermolecular attraction of water molecules. In other words, the ionized water prevents the oil nanoparticles from agglomerating. More particularly, nanometer sized oil particles can be formed by using a high pressure emulsifying device, and are dispersed in water through the intermolecular attraction of water molecules, thereby providing an emulsion.

Meanwhile, in step (c) of ionizing water, iron powder may be used as the metal catalyst. The metal catalyst contributes to the ionization of water via a redox reaction. In addition to iron powder, zinc or aluminum powder may also be used as the metal catalyst. Platinum powder may be used.

Preferably, the water used in step (c) is distilled water. In a preferred embodiment of the present invention, the water may be used in an amount of 50˜100 parts by weight based on 100 parts by weight of the oil.

The oil that may be used in the present invention is not particularly limited. Preferably, the oil is vegetable oil, considering its effect upon the environment or its safety to the human body. Particular examples of the vegetable oil include, but are not limited to, soybean oil, canola oil, sunflower seed oil, palm oil, cottonseed oil, rapeseed oil and various kinds of essences. More preferably, soybean oil is used.

To prepare the fungicidal composition according to the present invention, an emulsifier is used. The emulsifier functions to emulsify the oil particles in water. Conventional emulsifiers may be used in the present invention. The emulsifier may be used in an amount of 5˜30 parts by weight based on 100 parts by weight of the oil.

Particular examples of the emulsifier include, but are not limited to, fatty acid copolymers; for example, nonionic emulsifiers such as polyglycerin fatty acid esters or sorbitan fatty acid esters.

The fungicidal composition according to the present invention may further comprise additives such as a spreading agent, a diffusing agent, and a penetrating agent, or the like, if desired.

The present invention also provides a fungicidal composition obtained by the above method. More particularly, the fungicidal composition according to the present invention comprises, based on 100 parts by weight of oil, 5˜30 parts by weight of the emulsifier and 50˜100 parts by weight of water, wherein the water is ionized, the oil is present as particles with a particle diameter of 20˜50 nm. Also, the oil particles are dispersed in the ionized water to provide water-in-oil (w/o) type emulsion.

When the fungicidal composition according to the present invention is used for controlling fungi, it may be diluted with a solvent such as water, depending on the subject to be prevented from fungi and on environmental conditions. The fungicidal composition may be used after it is diluted in a ratio of 1:250˜1:500. For example, 1 L of the composition according to the present invention is diluted with 250˜500 L of water, and then the diluted composition is sprayed uniformly onto plant stems or leaves at a predetermined interval of 5˜10 days so as to prevent harmful fungi from growing.

The composition according to the present invention may be useful for the prevention or extermination of Sphaerotheca fusca (powdery mildew), botrytis cinerea, anthrax or downy mildew.

### BRIEF DESCRIPTION OF THE DRAWINGS

The foregoing and other objects, features and advantages of the present invention will become more apparent from the following detailed description when taken in conjunction with the accompanying drawings in which:

FIG. 1a is a photograph taken with a magnification of 600, which shows the fungicidal composition of Example 1 according to the present invention, 1 hour after it is diluted with water in a ratio of 1:300 (preferable dilution ratio);

FIG. 1b is a photograph taken with a magnification of 600, which shows the fungicidal composition of Comparative Example 2 as an oil agent according to the prior art, 1 hour after it is diluted with water in a ratio of 1:50 (preferable dilution ratio);

FIGS. 2a˜2c are photographs; each showing variations in fungous spores, as observed after applying the fungicidal composition according to the present invention (Example 1), diluted with water, to fungi (Sphaerotheca fusca; powdery mildew), wherein FIG. 2a is a photograph showing the oil particles of the inventive fungicidal composition, attached to the fungous spores; FIG. 2b is a photograph showing the fungous spores, five minutes after the application of the composition, the spores being expanded due to the infiltration of the oil particles; and FIG. 2c is a photograph showing the spores, in which the inside materials and cell walls are destructed, 8 to 10 minutes after the application of the composition;

FIG. 3 is a photograph showing the oil particles of the fungicidal composition according to the present invention, which are attached to hyphae of fungi (botrytis cinerea), after applying the same composition diluted with water to the same hyphae; and

FIG. 4 is a photograph that shows the results obtained from the test for determining whether the fungicidal composition according to the present invention adversely affects plants or not, after cultivating lettuce with the same composition.

### BEST MODE FOR CARRYING OUT THE INVENTION

Reference will now be made in detail to the examples of the present invention; Comparative Examples; and Experimental Examples. It is to be understood that the following examples are illustrative only, and the scope of the present invention is not limited thereto.

### EXAMPLE 1

First, 100 parts by weight of soybean oil were mixed with 12 parts by weight of polyglycerin fatty acid ester (fatty acid copolymer as an emulsifier), and the resultant mixture was preheated to about 50˜60° C.

Meanwhile, 80 parts by weight of water (60° C.) and 1.5 parts by weight of iron powder as a metal catalyst were introduced into a container, and a high voltage of 50,000V was applied to the water from an exterior source for 30 seconds to provide ionized distilled water.

Then, the mixture containing soybean oil and the emulsifier was sprayed to the ionized distilled water by using a high pressure spraying device under a pressure of 350 psi, with stirring at 8000˜9000 rpm to provide a fungicidal composition according to the present invention.

The oil particle diameter in the fungicidal composition obtained as described above was measured by using a size measuring device available from Zetasizer Nano (UK). After the measurement, the composition had an oil particle diameter of 20˜50 nm.

### COMPARATIVE EXAMPLE 1

Example 1 was repeated to provide a fungicidal composition, except that non-treated distilled water was used instead of the ionized distilled water.

The composition had an oil particle diameter of 40˜120 nm.

### COMPARATIVE EXAMPLE 2

A fungicidal composition was provided in the same manner as a commercially available oil-based fungicidal agent. In other words, 93% of soybean oil was mixed with 7% of sorbitan fatty acid ester to provide a fungicidal composition.

### EXPERIMENTAL EXAMPLE 1

Oil/Water Separation Test with Time

The fungicidal compositions according to Example 1 and Comparative Example 1 were diluted with water in a ratio of 1:300 (volume ratio of the composition: water), and the composition was diluted with water in a ratio of 1:50. Then, oil/water separation was observed in each composition with the lapse of time.

Meanwhile, the fungicidal composition according to Comparative Example 2 had an initial oil particle diameter of about 0.5˜10 μm after it is diluted with water.

The test results are shown in the following Table 1.

TABLE 1

| | | | After | | | |
|---|---|---|---|---|---|---|
| | After | After | 10 | After | After | After |
| | 1 min. | 5 mins. | mins. | 30 mins. | 1 hr. | 24 hrs. |
| Ex. 1 | +++++ | +++++ | +++++ | +++++ | +++++ | ++++ |
| Comp. Ex. 1 | +++++ | ++++ | ++++ | +++ | +++ | ++ |
| Comp. Ex. 2 | +++++ | ++++ | +++ | + | − | − |

Emulsifying Degree:
− 0%,
+ 20%,
++ 40%,
+++ 60%,
++++ 80%,
+++++ 100%

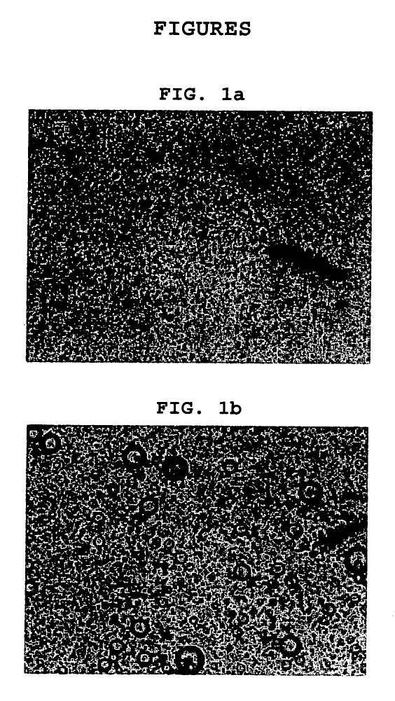

FIGS. 1a and 1b are photographs taken with a magnification of 600, each showing the results for the dilution test. FIG. 1a is a photograph, which shows the fungicidal composition of Example 1 according to the present invention, 1 hour after it is diluted with water in a ratio of 1:300, and FIG. 1b is a photograph, which shows the fungicidal composition of Comparative Example 2, 1 hour after it is diluted with water in a ratio of 1:50.

As shown from the above results, the fungicidal composition according to the present invention shows no variations in the dispersion of particles after 1 hour, while the fungicidal compositions according to Comparative Examples 1 and 2 (particularly, the composition according to Comparative Example 2) cause agglomeration of oil particles, resulting in oil/water separation.

### EXPERIMENTAL EXAMPLE 2

Fungicidal Activity Test

The fungicidal compositions according to Example 1, Comparative Example 1 and Comparative Example 2 were diluted with water, in a ratio of 1:300, 1:150 and 1:50, respectively. Each fungicidal composition was sprayed to powdery mildew, botrytis cinerea, glomerella cingulata or downy mildew, present in plants. Then, fungicidal effect was measured 24 hours after the application. In the case of fungi, fungicidal effect was expressed by the area occupied by the fungi. The results are shown in the following Table 2.

In Table 2, each number expressed in percent units represents the area in which the fungi are controlled. For example, a fungicidal effect of 20% means that the area, in which the fungi are controlled, is 20% of the total area of fungi.

TABLE 2

| | | Botrytis | Glomerella | Downy |
|---|---|---|---|---|
| | Powdery mildew | cinerea | cingulata | mildew |
| Ex. 1 | +++++ | +++++ | +++++ | ++++ |
| Comp. Ex. 1 | ++++ | ++++ | ++++ | +++ |
| Comp. Ex. 2 | ++ | + | + | + |

Fungicidal Effect:
+ 20%,
++ 40%,
+++ 60%,
++++ 80%,
+++++ 100%

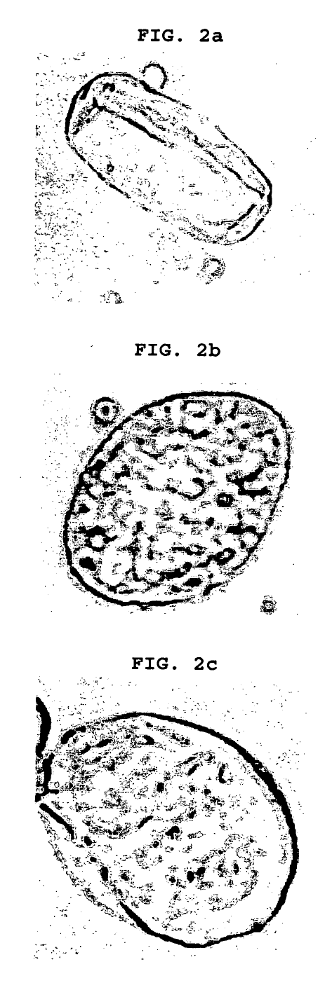

FIGS. 2a˜2c are photographs showing the above test results. FIG. 2a is a photograph showing the oil particles of the inventive fungicidal composition (Example 1), attached to the fungous spores of powdery mildew. FIG. 2b is a photograph showing the fungous spores, five minutes after the application of the composition, the spores being expanded due to the infiltration of the oil particles. FIG. 2c is a photograph showing the spores, in which the inside materials and cell walls are destructed, 8 to 10 minutes after the application of the composition.

Additionally, FIG. 3 is a photograph showing the oil particles of the fungicidal composition of Example 1 according to the present invention, which are attached to hyphae of botrytis cinerea, after applying the same composition diluted with water to the same hyphae.

### EXAMPLE 3

Test for Viscosity Increase at Low Temperature

The compositions diluted in Experimental Example 1 (i.e. the fungicidal compositions according to Example 1 and Comparative Example 1, diluted with water in a ratio of 1:300 and 1:50, respectively) were measured for viscosity depending on temperatures. The test results are shown in the following Table 3.

TABLE 3

Temperature (° C.)

| | 0 | 10 | 25 | 40 |
|---|---|---|---|---|
| Ex. 1 | 65 c.p | 31 c.p | 18 c.p | 10 c.p |
| Comp. Ex. 1 | 72 c.p | 36 c.p | 22 c.p | 13 c.p |
| Comp. Ex. 2 | 160 c.p | 89 c.p | 45 c.p | 25 c.p |

c.p: centipoises

### EXPERIMENTAL EXAMPLE 4

Test for Damage to Plants

The fungicidal composition according to Example 1 was diluted with water in a ratio of 1:10, 1:100, 1:250 and 1:500 to provide samples. As a control, water containing no fungicidal composition was used.

Lettuce samples were divided into five groups, and each group was treated independently with any one of the above samples and the control, repeatedly for 4 weeks at an interval of 7 days. The treatment was performed by way of perfusion (spraying) and dipping (infiltration). Then, 24 hours after the last treatment, each lettuce group was observed to determine whether it is damaged or not. The test results are shown in the following Table 4.

TABLE 4

| | Roots | Stems | Leaves | Photosynthesis |
|---|---|---|---|---|
| Non-treated | Normal | Normal | Normal | Normal |
| 1:10 dilution | Normal | Normal | Normal | Normal |
| 1:100 dilution | Normal | Normal | Normal | Normal |
| 1:250 dilution | Normal | Normal | Normal | Normal |
| 1:500 dilution | Normal | Normal | Normal | Normal |

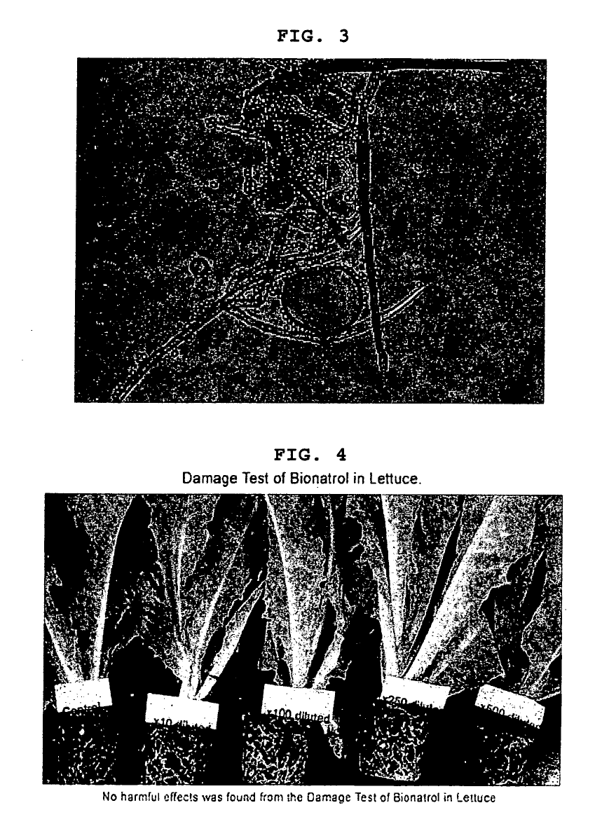

As shown in Table 4, the fungicidal composition according to the present invention does not adversely affect the plants. The results are also shown in FIG. 4. FIG. 4 shows the test results for the control and the lettuce groups treated with the samples, each diluted in a ratio of 1:10, 1:100, 1:250 and 1:500, in turn, when viewed from the left side to the right side.

### INDUSTRIAL APPLICABILITY

As can be seen from the foregoing, the fungicidal composition according to the present invention, which comprises oil present as nano-sized particles, an emulsifier and ionized distilled water, provides an improved fungicidal effect, prevents the problems of oil/water separation upon dilution and an increase in viscosity at low temperature, and does not adversely affect plants.

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

1. A method for preparing a fungicidal composition comprising nanometer sized oil particles, which comprises the steps of:
(a) mixing oil with an emulsifier;
(b) preheating the mixture obtained from step (a) to 50˜60° C.;
(c) applying a high voltage to water to perform ionization of water; and
(d) injecting the mixture obtained from step (b) into the ionized water obtained from step (c) by using a high-pressure spraying device with stirring to allow the oil to be dispersed in the ionized water in a state of nanometer sized particles.

2. The method according to claim 1, wherein the oil particles have a particle diameter of 20˜50 nm.

3. The method according to claim 1, wherein step (c) of ionizing water comprises treating the water at a high voltage in the presence of a metal catalyst.

4. The method according to claim 1, wherein the high voltage ranges from 10,000V to 60,000V.

5. The method according to claim 1, wherein the high voltage applied in step (c) is also applied in step (d).

6. The method according to claim 3, wherein the metal catalyst is selected from the group consisting of iron, zinc, aluminum and platinum.

7. The method according to claim 1, wherein the water is distilled water.

8. The method according to claim 1, wherein the oil is vegetable oil.

9. The method according to claim 1, wherein the oil is selected from the group consisting of soybean oil, corn oil, canola oil, sunflower seed oil, palm oil, cotton seed oil and rapeseed oil.

10. The method according to claim 1, wherein the emulsifier is used in an amount of 5˜30 parts by weight based on 100 parts by weight of the oil.

11. The method according to claim 1, wherein the emulsifier is selected from the group consisting of polyglycerin fatty acid esters and sorbitan fatty acid esters.

12. The method according to claim 1, wherein the water is used in an amount of 50˜100 parts by weight based on 100 parts by weight of the oil.

13. A fungicidal composition obtained by the method as defined in claim 1.

14. A fungicidal composition present as an oil-in-water (o/w) type emulsion, which comprises 5˜30 parts by weight of an emulsifier and 50˜100 parts by weight of water based on 100 parts by weight of oil, wherein the water is ionized, and the oil is dispersed in the ionized water in a state of particles having a particle diameter of 20˜50 nm.

15. The fungicidal composition according to claim 14, which controls powdery mildew, botrytis cinerea, anthrax or downy mildew.
